(19) United States
(12) Patent Application Publication
(10) Pub. No.: US 2013/0317158 A1
(43) Pub. Date: Nov. 28, 2013

(54) USE OF CALCIUM HYPOPHOSPHITE AS A FILLER TO INCREASE MECHANICAL PROPERTIES OF A POLYAMIDE COMPOSITION

(71) Applicants: Floryan De Campo, Shanghai (CN); Annelyse Murillo, Shanghai (CN); Junli Li, Shanghai (CN); Tingting Zhang, Shanghai (CN)

(72) Inventors: Floryan De Campo, Shanghai (CN); Annelyse Murillo, Shanghai (CN); Junli Li, Shanghai (CN); Tingting Zhang, Shanghai (CN)

(73) Assignee: RHODIA (CHINA)CO., LTD., Shanghai (CN)

(21) Appl. No.: 13/984,897

(22) PCT Filed: Feb. 24, 2011
(86) PCT No.: PCT/CN2011/071247

§ 371 Date: Aug. 12, 2013

(51) Int. Cl. C08K 3/32

(52) U.S. Cl. CPC C08K 3/32
USPC 524/414

(57) ABSTRACT

The use of a heat stabilized calcium hypophosphite as a filler to increase the mechanical properties of a polyamide composition is described. The composition can also involve reinforcing and/or bulking filler and/or impact modifier agents. Using such a filler one can obtain a polyamide composition having very good mechanical performance with the calcium hypophosphite having a low degree of phoshpine generation.

The present invention concerns the use of a heat stabilized calcium hypophosphite as a filler to increase the mechanical properties of a polyamide composition. Said composition may also comprise reinforcing and/or bulking filler and/or impact modifier agents. The invention permits to obtain polyamide composition providing very good mechanical performances with the use of a calcium hypophosphite having a low degree of phosphine generation.

### INVENTION

The applicant has discovered that the use of a specific heat stabilized calcium hypophosphite, in polyamide-based compositions makes it possible to increase the mechanical properties said compositions, thus making it possible to act as a filler. An optimum level of compromise between mechanical properties is in particular obtained when the polyamide composition comprises from 0.1 to 15% by weight of said calcium hypophosphite, relative to the total weight of the composition.

The present invention concerns the use of a heat stabilized calcium hypophosphite as a filler to increase the mechanical properties of a polyamide composition; said calcium hypophosphite is so heat stabilized that, when it is heated during 3 hours at 298° C. under a flow of argon flushing at rate 58 mL/min, it generates less than 0.5 mL of phosphine per gram of calcium hypophosphite.

Preferably according to this test it generates less than 0.1, more preferably less than 0.05, particularly less than preferably less than 0.02 mL of phosphine per gram of calcium hypophosphite.

The present invention also concerns a method for increasing mechanical properties of a polyamide composition in which a heat stabilized calcium hypophosphite is added to said polyamide composition.

Such a heat stabilized calcium hypophosphite can be stabilized by a method comprising the steps of:
step a) washing a calcium starting hypophosphite at least one time under a controlled value of pH comprised between 4 and 11, preferably between 5 and 8, said calcium hypophosphite being in an aqueous solution and/or in a solid state, and
step b) drying the calcium hypophosphite as obtained after the washing operation(s) of step (a) under reduced pressure to remove the volatiles.

The organic solvent used in step a) described above is preferably selected from the group comprising acetone, methanol, isopropanol, tetrahydrofurane, and acetonitrile.

The starting calcium hypophosphite of step a) may be in the form of an aqueous solution, charged in a reactor and mixed with a mineral or an organic acid to obtain a slurry whose pH is set at a value of between 4 and 6.5, preferably 5 and 6, the acid being preferably selected from the group comprising hypophosphorous acid, citric acid, maleic acid, acetic acid, chlorhydric acid and sulphuric acid, acid hypophosphorous acid being more preferable.

Wherein the starting calcium hypophosphite of step a) is in the form of an aqueous solution, charged in a reactor and mixed with a mineral or an organic base to obtain a slurry whose pH is set at a value of between 7.5 and 11, preferably 8 and 10, the base is preferably selected from the group comprising sodium hydroxide, potassium hydroxide, calcium hydroxide, calcium oxide, magnesium oxide and magnesium hydroxide, the base being more preferably calcium hydroxide and/or calcium oxide.

The starting calcium hypophosphite may come from the reaction of calcium oxide, water and hypophosphorous acid. The hypophosphite salts and, especially, calcium hypophosphite, can be prepared for example from white phosphorus (P₄) reacted under alkaline conditions with calcium hydroxide or calcium oxide and water as taught by U.S. Pat. No. 5,225,052. It is also possible to obtain calcium hypophosphite by reaction of a calcium salt or simply from lime as taught by Chinese patent CN101332982, with hypophosphorous acid. For example the lime suspension is simply neutralized with hypophosphorous acid, the impurities are removed by filtration and the product isolated in a same way as previously described. It is also possible to obtain calcium hypophosphite from other metallic hypophosphites or the acid by ion exchange process.

The process for stabilizing the starting hypophosphite salt which is useful for preparing the polymer composition of the invention can be batch, continuous or semi-continuous and be performed in a close or open system under inert atmosphere. That inert atmosphere can be for example carbon dioxide, argon, or nitrogen.

The process for stabilizing the starting hypophosphite salt can be performed under atmospheric pressure, under pressure or under vacuum.

Without linking the current invention to any theoretical rationale, it looks like most of the premature instability is due to the presence of problematic impurities. The quality of the hypophosphite salts may be determined by detecting the remaining impurities using thermal analysis tools such as ARC (Adiabatic Reaction Calorimeter) and TGA (Thermal Gravimetric Analysis). The test can be carried out at any stage during the heating process described before.

Another way to check the quality of the heat stabilized hypophosphite salt used in the instant invention, is to perform a stability test at elevated temperature on the product, alone or mixed with plastic and measure the amount of phosphine generated during the test. It is also possible to measure the amount of phosphine generated when the product is compounded with plastics such as polyamide.

The polyamide composition may comprise from 0.1 to 15% by weight of calcium hypophosphite, preferably between 0.5% and 15% by weight, more preferably between 1% and 10% by weight, relative to the total weight of the composition.

The calcium hypophosphite content into the polyamide matrix may be measured according to well known technical methods, such a NMR or titration notably after dissolution of the polyamide with an appropriate solvent.

The polyamide composition according to the invention comprises a polyamide as main matrix.

As polyamides that may be used according to the invention, mention may be made of semicrystalline or amorphous polyamides and/or copolyamides, such as aliphatic polyamides, semiaromatic polyamides and, more generally, linear polyamides obtained by polycondensation between a saturated aliphatic or aromatic diacid and a saturated aromatic or aliphatic primary diamine, polyamides obtained by condensation of a lactam, or an amino acid, or linear polyamides obtained by condensation of the mixture of these various monomers. More specifically, these copolyamides may be, for example, polyhexamethyleneadipamide, polyphthalamides obtained from terephthalic and/or isophthalic acid, and copolyamides obtained from adipic acid, hexamethylenediamine and caprolactam.

The polyamide may be selected from the group consisting of polyamide 6, polyamide 66, polyamide 610, polyamide 11, polyamide 12, polyamide 612, poly(meta-xylylenediamine) (MXD6), polyamide 66/6T, polyamide 66/61, and blends and copolyamides, such as copolyamide 6.66, for example.

The composition of the invention may also comprise copolyamides derived in particular from the above polyamides, or blends of these polyamides or copolyamides.

A polyamide matrix comprising type 66 polyamides and/or type 6 polyamides is in particular preferred. The preferred polyamides are polyhexamethylene adipamide, polycaprolactam, or copolymers and blends between polyhexamethyleneadipamide and polycaprolactam.

Polyamides having molecular weights suitable for injection-molding processes, for example with a viscosity index VI of between 100 and 160 ml/g, according to standard ISO 307, are generally used; however, polyamides of lower viscosity may also be used.

The polyamide matrix may in particular be a polymer comprising star or H macromolecular chains and, where appropriate, linear macromolecular chains. Polymers comprising such star or H macromolecular chains are, for example, described in documents FR2743077, FR2779730, U.S. Pat. No. 5,959,069, EP0632703, EP0682057 and EP0832149.

According to another particular variant of the invention, the polyamide matrix of the invention may be a polymer of random tree type, preferably a copolyamide having a random tree structure. These copolyamides of random tree structure and the process for obtaining them are described in particular in document WO 99103909. The matrix of the invention may also be a composition comprising a linear thermoplastic polymer and a star, H and/or tree thermoplastic polymer, as described above. The matrix of the invention may also comprise a hyperbranched copolyamide of the type described in document WO 00/68298. The composition of the invention may also comprise any combination of linear, star, H, tree, hyperbranched copolyamide thermoplastic polymer as described above.

The composition according to the invention comprises in particular from 10% to 90% by weight of polyamide, preferably from 40% to 80% by weight of polyamide, relative to the total weight of the composition.

In order to further improve the mechanical properties of a polyamide composition according to the invention, it may be advantageous to add thereto at least a reinforcing and/or bulking filler, preferably selected from the group consisting of fibrous fillers such as glass fibers, carbon fibers and aramid fibers, and nonfibrous mineral fillers such as clays, kaolin, wollastonite, silica, talc or nanoparticles. The level of incorporation of reinforcing and/or bulking filler is in accordance with the standards in the composite materials field. The level of filler may, for example, be from 1% to 80%, preferably from 10% to 70%, in particular between 30% and 60%.

The present invention also concerns a polyamide composition comprising at least the heat stabilized calcium hypophosphite as defined and an impact modifier agent.

According to the invention, the term “impact modifier agent” is intended to mean a compound capable of modifying the impact strength of a polyamide composition. These impact-modifier compounds comprise functional groups that react with the polyamide. The expression “functional groups that react with the polyamide” is intended to mean groups capable of reacting or of interacting chemically with the acid or amine functions of the polyamide, in particular by covalence, ionic or hydrogen interaction or van der Walls bonding. Such reactive groups make it possible to provide good dispersion of the impact modifiers in the polyamide matrix. Good dispersion in the matrix is generally obtained with impact-modifier particles having a size of between 0.1 and 1 μm.

The impact modifiers may very well comprise, in themselves, functional groups that react with the polyamide, for example as regards ethylene acrylic acid (EAA). It is also possible to attach thereto functional groups that react with the polyamide, generally by grafting or copolymerization, for example for ethylene-propylene-diene (EPDM) grafted with maleic anhydride.

According to the invention, use may be made of the impact modifiers, which are oligomeric or polymeric compounds, comprising at least one of the following monomers, or a mixture thereof: ethylene, propylene, butene, isoprene, diene, acrylate, butadiene, styrene, octene, acrylonitrile, acrylic acid, methacrylic acid, vinyl acetate, vinyl esters such as acrylic and methacrylic esters, and glycidyl methacrylate. The compounds may also comprise, in addition, monomers other than those mentioned above.

The base of the impact-modifier compound, optionally referred to as elastomeric base, can be chosen from the group comprising: polyethylenes, polypropylenes, polybutenes, polyisoprenes, ethylene-propylene rubbers (EPRs), ethylene-propylene-diene rubbers (EPDMs), ethylene butene rubbers, ethylene acrylate rubbers, butadiene styrene rubbers, butadiene acrylate rubbers, ethylene octene rubbers, butadiene acrylonitrile rubbers, ethylene acrylic acids (EAAs), ethylene vinyl acetate (EVAs), ethylene acrylic esters (EEAs), acrylonitrile-butadiene-styrene (ABS) copolymers, styrene-ethylene-butadiene-styrene (SEBS) block copolymers, styrene-butadiene-styrene (SBS) copolymers, core-shell elastomers of methacrylate-butadiene-styrene (MBS) type, or blends of at least two elastomers listed above.

In addition to the groups listed above, these impact modifiers may also comprise, generally grafted or copolymerized, functional groups that react with the polyamide a), such as, in particular, functional groups as follows: acids, such as carboxylic acids, salified acids, esters, in particular acrylates and methacrylates, ionomers, glycidyl groups, in particular epoxy groups, glycidyl esters, anhydrides, in particular maleic anhydrides, maleimides, or mixtures thereof.

Such functional groups on the elastomers are, for example, obtained by using a comonomer during the preparation of the elastomer.

As impact modifiers comprising functional groups that react with the polyamide a), mention may in particular be made of ethylene/acrylic ester/glycidyl methacrylate terpolymers, ethylene/butyl ester acrylate copolymers, ethylene/n-butyl acrylate/glycidyl methacrylate copolymers, ethylene/maleic anhydride copolymers, maleic anhydride-grafted styrene/maleimide copolymers, copolymers of styrene/ethylene/butylene/styrene modified with maleic anhydride, maleic anhydride-grafted styrene/acrylonitrile copolymers, maleic anhydride-grafted acrylonitrile/butadiene/styrene copolymers, and hydrogenated versions thereof.

The proportion by weight of the impact modifiers agents of the invention in the total composition is in particular between 0.1% and 50%, preferably between 1% and 30%.

The polyamide composition may also comprise one or more other polymers, preferably thermoplastic polymers such as polyamide, polyolefins, ABS or polyester.

The composition according to the invention may also comprise additives normally used for the manufacture of polyamide compositions intended to be molded. Thus, mention may be made of lubricants, flame retardants, plasticizers, nucleating agents, catalysts, light and/or thermal stabilizers, antioxidants, antistatic agents, colorants, pigments, matting agents, conductive agents, such as carbon black, molding additives or other conventional additives.

For the preparation of a polyamide composition, these fillers and additives may be added to the polyamide by conventional means suitable for each filler or additive, for instance during the polymerization or as a molten mixture. The calcium hypophosphite is preferably added to the polyamide in a melt process, in particular during a step of extrusion of the polyamide, or in a solid process in a mechanical mixer; the solid mixture may then be melted, for example by means of an extrusion process.

The compositions according to the invention may be used as raw material in the field of plastics processing, for example for the preparation of articles formed by injection-molding, by injection/blow-molding, by extrusion or by extrusion/blow-molding. According to one customary embodiment, the modified polyamide is extruded in the form of rods, for example in a twin-screw extrusion device, said rods then being chopped into granules. The molded components are then prepared by melting the granules produced above and feeding the molten composition into injection-molding devices.

As articles obtained from the composition according to the invention mention may, for example, be made of articles in the motor vehicle industry, such as components under the engine hood, bodywork components, tubes and tanks, or articles in the electrical and electronics field, such as connecters.

Specific language is used in the description so as to facilitate the understanding of the principle of the invention. It should, however, be understood that no limitation of the scope of the invention is envisioned by the use of this specific language. Modifications, improvements and perfections may in particular be envisioned by those skilled in the art in the technical field concerned, on the basis of their own general knowledge.

The term “and/or” includes the meanings “and”, “or” and also all the other possible combinations of the elements connected to this term.

Other details and advantages of the invention will emerge more clearly in the light of the examples given below, which are given only by way of indication.

### EXPERIMENTAL PART

Compositions based on polyamide (PA66 23A from the company Rhodia, having a VI of 110 ml/g according to standard ISO 307) are obtained by extrusion on a Coperion ZSK 40D twin-screw extruder, adding varying amounts of heat stabilized calcium hypophosphite and 30% weight of glass fibers.

Calcium hypophosphite (102 g) made from the commercial grade of calcium hypophosphite sourced from Shanghai Lingfeng chemical reagent co., ltd is charged in a reactor and mixed with water (161 g). 50% hypophosphorous acid (34 g) is then added slowly and the mixture is thoroughly stirred for 30 minutes and the pH is controlled between 4 and 6. Then, the slurry is filtered to afford 75 g of solid. This solid is washed with water (40 g) and then with acetone (75 g). 57.8 g of wet solid is thus obtained to finally afford 56 g of dry calcium hypophosphite after evaporation of the volatiles under reduced pressure overnight at room temperature.

Then, the resulting calcium hypophosphite is heated during 3 hours at 298° C. under a flow of argon flushing at rate 58 mL/min. The out gases are bubbled through a 5% hydrogen peroxide solution to scrub phosphine that may be generated. The scrubber solution is then analyzed by Ion Chromatography (IC) to determine the level of phosphate. The phosphine generated is then calculated by assuming that all the phosphate detected is issued from phosphine. It appears than that the heat stabilized calcium hypophosphite generates 0.015 mL of phosphine (PH₃) per gram of calcium hypophosphite.

By contrast calcium hypophosphite made from the commercial grade of calcium hypophosphite sourced from Shanghai Lingfeng chemical reagent co., ltd without specific treatment is generating too much phosphine to be safely used into polyamide and do not permit to proceed to an extrusion.

The operating characteristics are as follows:

Twin-screw extruder: Coperion ZSK, with
temperature profile: 245-250-250-250-250-250 ° C.
screw speed (rpm): 600
Torque (%): 60
vacuum: −0.05 Mpa.

Test specimens are prepared by injection-molding in the following way:

LGH 80D-GC injection machine

T(° C.) sheath: from 250 to 260

T(° C.) mold: 80-90

Injection speed (mm/s): 30-40 mm/s

Injection pressure (bar): 50-60

Maintenance pressure (bar): 25

Counterpressure (bar): 3

Screw speed (rpm): 110

Various properties are measured and mentioned in Table 1:

TABLE 1

| Formulation | | Standard | 1 | 2 | 3 |
|---|---|---|---|---|---|
| PA66 | | | 69 | 65 | 60 |
| Glass fiber | | | 30 | 30 | 30 |
| CaHypo | | | 1 | 5 | 10 |
| Density | g/cm³ | ISO 1183-A | 1.379 | 1.4 | 1.433 |
| Tensile | Mpa | ISO 527-2 | 161 | 182 | 182 |
| strength | | | | | |
| Strength | % | ISO 527-2 | 2.1 | 2.7 | 2.9 |
| at break | | | | | |
| Flexual | Mpa | ISO 178 | 253 | 268 | 271 |
| strength | | | | | |
| Flexual | MPa | ISO 178 | 9341 | 9666 | 10572 |
| modulus | | | | | |
| Unnotched | KJ/m² | ISO 179-1eU | 63.5 | 84.1 | 83.3 |
| Charpy impact | | | | | |

During the extrusion the out gases and the concentration of phosphine is measured over time using Gastec tubes. When samples of vent gases are analyzed no phosphine could be detected indicating that the level of phosphine is inferior to 0.05 ppm.

1. A method of improving mechanical properties of a polyamide composition, the method comprising using a heat stabilized calcium hypophosphite as a filler to improve the mechanical properties of the polyamide composition; wherein the calcium hypophosphite is heat stabilized so that, when it is heated during 3 hours at 298° C. under a flow of argon flushing at rate 58 mL/min, it generates less than 0.5 mL of phosphine per gram of calcium hypophosphite.

2. The method of claim 1, wherein the heat stabilized calcium hypophosphite is stabilized by a method comprising the steps of:
step a) washing a calcium starting hypophosphite at least one time under a controlled value of pH of between 4 and 11 , said calcium hypophosphite being in an aqueous solution and/or in a solid state, and
step b) drying the calcium hypophosphite obtained after the washing operation(s) of step (a) under reduced pressure to remove volatiles.

3. The method of claim 1, wherein the polyamide composition comprises from 0.1% to 15% by weight of calcium hypophosphite, relative to the total weight of the composition.

4. The method of claim 1, wherein the polyamide composition comprises a semicrystalline or amorphous polyamide or copolyamide.

5. The method of claim 1, wherein the polyamide is selected from the group consisting of polyamide 6, polyamide 66, polyamide 610, polyamide 1 , polyamide 12, polyamide 612, poly(meta-xylylenediamine) (MXD6), polyamide 66/6T, polyamide 66/61, blends thereof, and copolyamides.

6. The method of claim 1, wherein the composition comprises from 10% to 90% by weight of polyamide, relative to the total weight of the composition.

7. The method of claim 1, wherein the composition comprises at least a reinforcing and/or a bulking filler.

8. The method of claim 1, wherein the composition comprises at least an impact modifier agent.

9. A composition comprising at least a polyamide, a heat stabilized calcium hypophosphite and an impact modifier agent, wherein the calcium hypophosphite is heat stabilized so that, when it is heated during 3 hours at 298° C. under a flow of argon flushing at rate 58 mL/min, it generates less than 0.5 mL of phosphine per gram of calcium hypophosphite.

10. A method of enhancing mechanical properties of a polyamide composition, the method comprising adding a heat stabilized calcium hypophosphite to the polyamide composition, wherein the calcium hypophosphite is heat stabilized so that, when it is heated during 3 hours at 298° C. under a flow of argon flushing at rate 58 mL/min, it generates less than 0.5 mL of phosphine per gram of calcium hypophosphite.
